(19) United States
(12) Patent Application Publication
(10) Pub. No.: US 2023/0158548 A1
(43) Pub. Date: May 25, 2023

(54) MOBILE CLASSIFYING OR SCREENING DEVICE

(71) Applicant: Neuson Hydrotec GmbH, Linz (AT)

(72) Inventor: Burghard PEYFUß, Weyer (AT)

(73) Assignee: Neuson Hydrotec GmbH, Linz (AT)

(21) Appl. No.: 17/918,467

(22) PCT Filed: Mar. 25, 2021
(86) PCT No.: PCT/EP2021/057843

§ 371 Date: Oct. 12, 2022

(30) Foreign Application Priority Data
Apr. 16, 2020 (AT) A 50322/2020

(51) Int. Cl. B07B 1/00; B07B 13/16; B07B 15/00; B03C 1/30

(52) U.S. Cl. CPC B07B 1/005; B03C 1/30; B07B 13/16; B07B 15/00; B03C 2201/20

(57) ABSTRACT

A mobile classifying or screening device, including frame for a classifying apparatus arranged on a chassis. The classifying apparatus has at least one screening surface for separating a fed screening material into at least two screened fractions. The frame includes two lateral frame parts which are formed of longitudinal bars running in the longitudinal direction, which are connected by webs running transversely to the longitudinal bars and which include a topmost longitudinal bar and a bottommost longitudinal bar. At least two transverse bars running in the the transverse direction, which interconnect the two lateral frame parts in the region of the respective bottommost longitudinal bars of the two lateral frame parts. The classifying apparatus is mounted on longitudinal bars and is adjacent to a storing and metering unit in the form of a trough-shaped feed channel having a substantially horizontal direction of discharge onto the screening surface.

The invention relates to a mobile classifying or screening device having a chassis and a frame arranged on the chassis for a classifying apparatus having at least one screening surface for separating a fed screening material into at least two screening fractions, wherein the chassis has a longitudinal direction oriented in the direction of travel and a transverse direction oriented perpendicular to the longitudinal direction, according to the preamble of claim 1.

Classifying or screening devices are known in various designs and are used to separate screening materials into screening fractions of different grain sizes with the aid of screening surfaces, screening in the actual sense, and sometimes also separation into fractions on the basis of properties other than grain size, for example with regard to magnetic properties, in which case they are referred to as classification. They are sometimes also used as downstream plant sections after crushers and shredders in order to process material mixtures and, if possible, to recycle them. For this purpose, there is also a need for mobile classifying or screening devices that can be moved to the respective location of the desired processing in order to be able to accomplish the separation into different fractions on site and to be able to process the processed material again on site while avoiding transport routes, or at least to be able to transport away fractions that have been reduced in quantity.

However, the transport of classifying or screening devices on public roads is by no means trivial, as these are usually large installations with a length of up to 20 meters and corresponding width and installation height. In order to make a classifying or screening device transportable on public roads, consideration must therefore be given to the dimensions of the device, which also has the effect of correspondingly reduced screening surfaces. Smaller screening surfaces in turn result in lower throughput and thus reduced performance of the mobile devices.

Known classifying or screening devices that can be moved on roads are also designed in such a way that they have a chassis with a running gear on which the functional components such as classifying apparatuses, drive or body elements are arranged. In order to ensure a correspondingly low body height, different device components are lined up and connected to continuous conveyors in the form of conveyor belts. In particular, the classifying apparatus is usually also fed by a conveyor belt with which the screening materials are fed to the classifying apparatus, which limits the applicability of such devices to screening materials with an edge length of less than 300 mm. A design of mobile classifying or screening devices as heavy-duty screening plants, which are also suitable for the processing of screening materials with grain sizes exceeding 300 mm edge length, is not known to the applicant in the prior art. In particular, the applicant is not aware of any mobile classifying or screening devices that can be fed directly with a wheel loader, since the construction heights of known classifying or screening devices in mobile design are too high for direct feeding with a wheel loader. Feeding known devices with an excavator would be theoretically conceivable, but disadvantageous from a practical point of view, since continuous feeding in the range of the possible throughput of mobile classifying or screening devices of, for example, 200 t/h cannot be achieved with an excavator. The classifying or screening device could thus only be operated very inefficiently.

It is therefore the object of the invention to provide a classifying or screening device which, on the one hand, is suitable as a mobile plant for transport on public roads and is thus designed as compact as possible, and, on the other hand, enables a higher material throughput than known designs of this type and can be used as a heavy-duty screening plant.

These objects are achieved by the features of claim 1. Claim 1 relates to a mobile classifying or screening device having a chassis and a frame arranged on the chassis for a classifying apparatus having at least one screening surface for separating a fed screening material into at least two screening fractions, wherein the chassis has a longitudinal direction oriented in the direction of travel and a transverse direction oriented perpendicular to the longitudinal direction. According to the invention, it is proposed for this purpose that the chassis comprises two lateral frame parts, which are each formed from longitudinal bars extending in the longitudinal direction, which are connected by webs extending transversely to the longitudinal bars and comprise an uppermost longitudinal bar and a lowermost longitudinal bar, and at least two transverse bars extending in the transverse direction, which connect the two lateral frame parts to one another in the region of their respective lowermost longitudinal bars, wherein the classifying apparatus is mounted on longitudinal bars and a storage and metering unit for the screened material is provided, which is arranged next to the classifying apparatus and mounted on longitudinal bars and which is designed as a trough-shaped feed channel having a substantially horizontal discharge direction for the screened material from the feed channel onto the adjacent screening surface.

The design of the frame according to the invention replaces the running gear mentioned at the beginning and the body elements arranged thereon and enables an extremely compact design. If the chassis is designed as a crawler chassis, for example, the frame parts can first be arranged so that their vertical projection is aligned with that of the crawler track of the crawler chassis, so that the maximum width of heavy-duty vehicles permitted for road transport can be optimally utilized both in terms of the track width of the crawler chassis and in terms of the overall width of the device. The screening surface can thus be increased because its dimension in the transverse direction can be maximized so that it lies within the range of this permitted maximum width. However, a larger screening surface compared to conventional designs also means a greater throughput of screening materials and thus a higher screening capacity of the classifying or screening device. The frame also forms a receiving space that can be optimally utilized not only in the transverse direction, but also in the vertical direction. According to the invention, this is achieved by means of the side-by-side arrangement of the classifying apparatus and the feed channel as well as the substantially horizontal discharge direction for the screening material from the feed channel onto the adjacent screening surface, which makes it possible to manage the mechanically excited conveying directions of the screening material in a substantially horizontal direction. An essentially horizontal discharge direction of the screening material from the feed channel onto the screening surface means in this context that, although small drop heights may occur, the change in height of the screening material in the transition from the feed channel to the adjacent screening surface is negligible compared to the other conveying distance of the screening material from the feed channel over the adjacent screening surface. As a result, very low installation heights can be achieved, so that, for example, direct feeding of the feed channel with a wheel loader is also possible. In the feed channel, the screening materials, which are sometimes fed in batches, are calmed and fed in measured quantities to the classifying apparatus. The classifying apparatus is designed, for example, as a vibration screening device known per se with a directed, elliptical vibration pattern, the screening surface of which is preferably aligned horizontally. However, slightly rising or falling screening surfaces would also be conceivable. The screening surfaces can be of different design and, for example, be held in a vibrating frame that is elastically coupled to a screen box, which in turn is elastically supported on longitudinal bars of the frame parts. The classifying apparatus further preferably has two screening surfaces in superimposed screening decks, wherein the upper screening surface separates a coarse fraction with oversizes from a medium/fine screening fraction, and the lower screening surface separates the medium coarse from the finest screening fraction. By avoiding ascending conveyor belts within the device and for feeding the classifying apparatus, the feeding of screening materials with very large diameters, in particular with edge lengths of more than 300 mm, is thereby made possible, so that the device according to the invention can also be used as a heavy-duty screening plant.

The longitudinal bars run essentially horizontally or have at least horizontally extending sections and serve mainly to support the classifying apparatus and the feed channel, while the upward and downward leading webs connecting the longitudinal bars lying one above the other serve mainly to stiffen the frame parts. The openings of the frame parts framed by the longitudinal bars and the webs also serve for the passage of transversely extending conveyors of separated screening fractions, as well as access openings for plant components such as drive and/or hydraulic equipment, as will be explained in more detail below.

The transverse bars can also be set very advantageously. Thus, according to an advantageous embodiment, it is proposed that the transverse bars comprise a front transverse bar lying in front of the chassis, as seen in the longitudinal direction, and an inner transverse bar lying behind the chassis, as seen in the longitudinal direction, wherein the inner transverse bar is connected to the front transverse bar by means of two longitudinal bars extending in the longitudinal direction. The terms “front” and “rear” are used here and subsequently merely for the purposes of linguistic differentiation and, in particular, do not refer to a direction of travel. The two longitudinal bars delimit a receiving space located between them, which represents the deepest receiving space of the entire device and can also be used to accommodate technical components in order to reduce the overall body height. If the chassis is designed as a crawler chassis, for example, this receiving space can even be located between the two crawler tracks of the crawler chassis.

This low-lying receiving space can preferably be used to arrange a continuous conveyor for discharging the finest screening fraction. In a corresponding manner, it is proposed that a fine fraction conveyor designed as a continuous conveyor be provided for a fine fraction forming the finest screening fraction, which conveyor has a horizontal conveying section which extends between the two longitudinal bars and begins in an end region of the longitudinal bars facing the inner transverse bar and, in an end region of the longitudinal bars facing the front transverse bar, merges into a rising conveying section, the discharge end of which lies above the front transverse bar. The horizontal conveying section thus extends within the device in the area close to the ground, since the finest screening fraction is obtained at the lowest point of the classifying apparatus. It extends below the classifying apparatus as well as below the feed channel and, in an end region of the longitudinal bars facing the front crossbar, changes into a rising conveyor section where it overhangs a front end of the device so that the finest screening fraction can be discharged from an elevated level at the discharge end in front of the device. In case of transportation of the mobile classifying and screening device, the fine fraction conveyor does not have to be disassembled or folded, but can remain unchanged inside the device.

With regard to the discharge of the coarser screening fractions, it is proposed that the two frame parts each have a central longitudinal bar extending between the uppermost longitudinal bar and the lowermost longitudinal bar, which, together with the respective lowermost longitudinal bar, in each case forms a discharge opening for the passage of continuous conveyors extending in the transverse direction for coarser screening fractions. The coarser screening fractions are obtained in a rear end of the device facing away from the front end of the device and discharged into lateral areas adjacent to the device. The discharge openings also represent assembly openings for the continuous conveyors, since the continuous conveyors for the coarser screening fractions protrude laterally from the device in the operating state and therefore have to be dismantled or folded in in the event of transport of the mobile classifying and screening device. With the help of the opening in the frame formed by the central longitudinal bar and the lowermost longitudinal bar, this disassembly is easily possible.

The classifying apparatus is preferably mounted on the horizontally extending central longitudinal bars, wherein it is supported on the central longitudinal bars by means of an elastic mounting, as mentioned. With regard to the storage and metering unit, it is proposed that it is mounted on the uppermost longitudinal bars, wherein they are also supported on the uppermost longitudinal bars via an elastic bearing. This facilitates an arrangement in which the upper screening surface of the classifying apparatus is located approximately at the level of the feed channel, allowing a substantially horizontal discharge direction for the screening material onto the screening surface.

With regard to the trough-shaped feed channel, it is proposed that it be designed as an integral vibratory feed channel. The term “integral” in this context is intended to mean that the trough bottom and the wall parts of the feed channel are designed as one piece and are moved together, in contrast to a design in which only a trough bottom is moved within wall parts that are stationary per se. The integral design and the movement of the entire feed channel enable faster discharge of the screening material onto the classifying apparatus, which is made possible by its greater throughput. This design also prevents clogging of the storage and metering unit, as repeatedly occurs in known designs when only one trough bottom is moved within stationary wall parts.

In order to further develop the present device as a classifying apparatus for magnetically attractable, for example ferrous, material components of the screening material, it is further proposed that continuous conveyors for discharging the screening fractions and magnetic separators arranged above the continuous conveyors are provided for classifying magnetically attractable material components of the respectively discharged screening fraction. The magnetic separators can be attached, for example, to holders, preferably height-adjustable, which project from the lateral frame parts. Alternatively, the magnetic separators can also be attached directly to the continuous conveyors, preferably by means of adjustment devices with which the magnetic separators can be adjusted relative to the continuous conveyors from a transport position, in which the magnetic separators essentially rest on the continuous conveyors, to a working position, in which the magnetic separators are arranged at an adjustable distance from the continuous conveyors. The adjustment devices can be operated manually-mechanically, hydraulically or electro-mechanically, and can be designed by means of a lever mechanism or linkage guides and the like. In the transport position, it is possible to dismantle or fold in the continuous conveyor with the magnetic separator attached to it. The magnetic separators are arranged above the discharge ends of the continuous conveyors for the discharged screening fractions and remove magnetically attractable material components from the respective discharged screening fraction. The height of the magnetic separators can be adjusted to different magnetization properties of the magnetically attractable material fractions. Preferably, layer height limiters or a layer height comparator can also be provided in order to optimally prepare the layer height of the discharged screening fractions for magnetic separation and thus improve the separation of magnetically attractable material components. One possible application is the classification of slags, where not only a separation into a very fine screening fraction, a medium coarse screening fraction as well as a coarse fraction for different possibilities of reuse takes place, but also a recovery of, for example, ferrous valuable materials. Since the continuous conveyors and the magnetic separators protrude laterally from the device in the operating state, they must be dismantled or folded in before the mobile classifying and screening device can be transported. For this purpose, it is conceivable to provide the device with a swivel crane-shaped construction and a hoist in order to facilitate assembly and disassembly of the magnetic separators as well as the continuous conveyors for the coarser screening fractions and also to enable individual operators.

It is also proposed that a maintenance opening for drive and/or hydraulic devices is formed between the uppermost longitudinal bar and the lowermost longitudinal bar of a frame part. The maintenance opening can also be used for replacing drive and/or hydraulic devices. These openings can of course also be closed with removable covers to provide sound and dust protection. Furthermore, it is advantageous to use noise-reducing materials on the noise-generating components of the device for reasons of noise protection.

Interesting further developments of the present device are also made possible in that the longitudinal bars and/or the webs are designed, at least in sections, as hollow profiles for holding fuel and/or hydraulic fluid. Their use as storage for fuel or hydraulic fluid makes it possible to dispense with bulky tanks, which in turn makes more compact designs possible. It is understood that the use of electric drives or hybrid drives is also possible. With regard to the hydraulic fluid, there is also the advantageous effect that hydraulic fluid heated during operation can be cooled by storing it in the outer longitudinal bars and/or webs.

The invention is explained in more detail below by means of exemplary embodiments with the aid of the accompanying figures, wherein the figures show as follows:

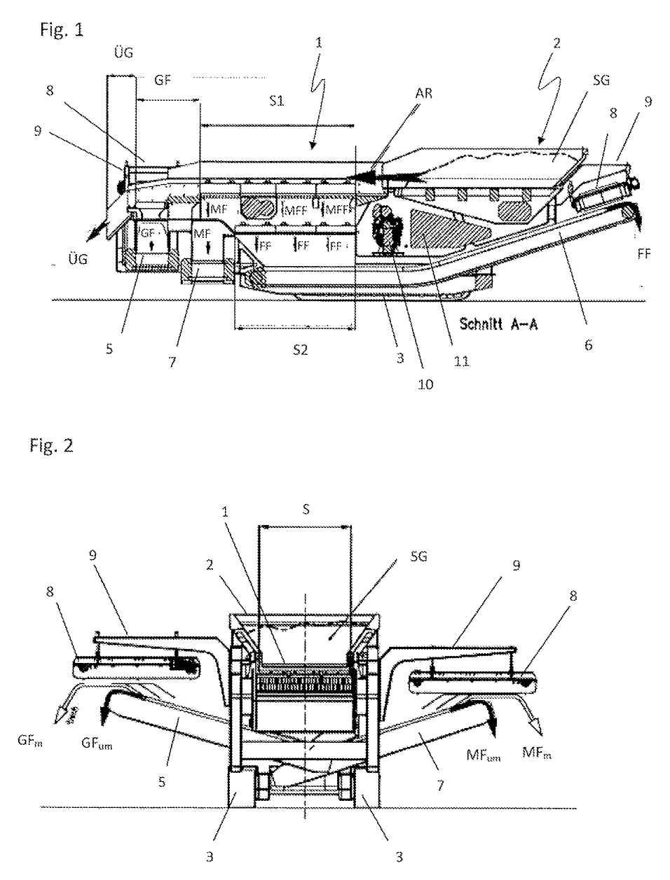

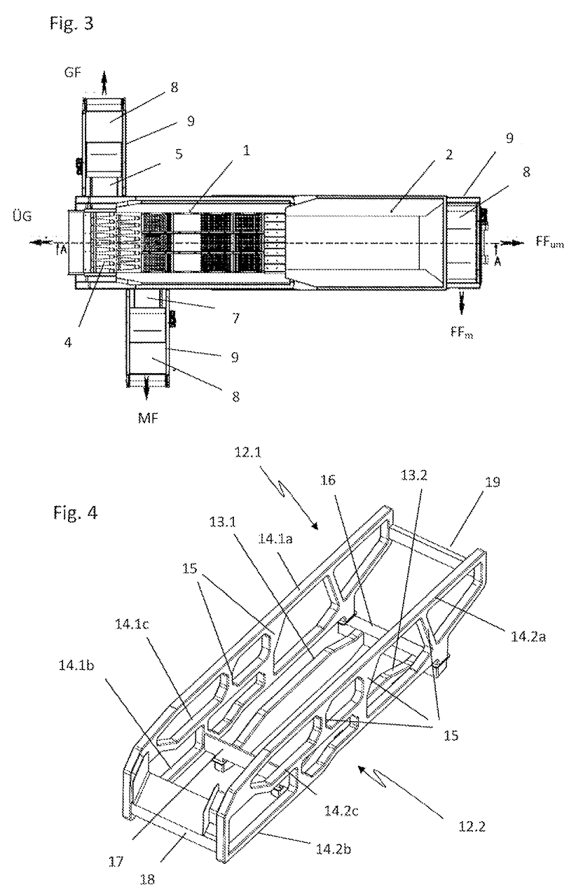

FIG. 1 shows a longitudinal section according to the sectional plane A-A (see FIG. 3) through an embodiment of a classifying or screening device according to the invention,

FIG. 2 shows a view of the classifying or screening device according to FIG. 1 from the left side as seen in relation to FIG. 1,

FIG. 3 shows the classifying or screening device according to FIG. 1 as seen from above,

FIG. 4 shows a perspective view of an embodiment of the frame with longitudinal beam for the classifying or screening device according to FIG. 1,

FIG. 5 shows a perspective view of an embodiment of the frame with longitudinal beam and the crawler tracks for the classifying or screening device according to FIG. 1,

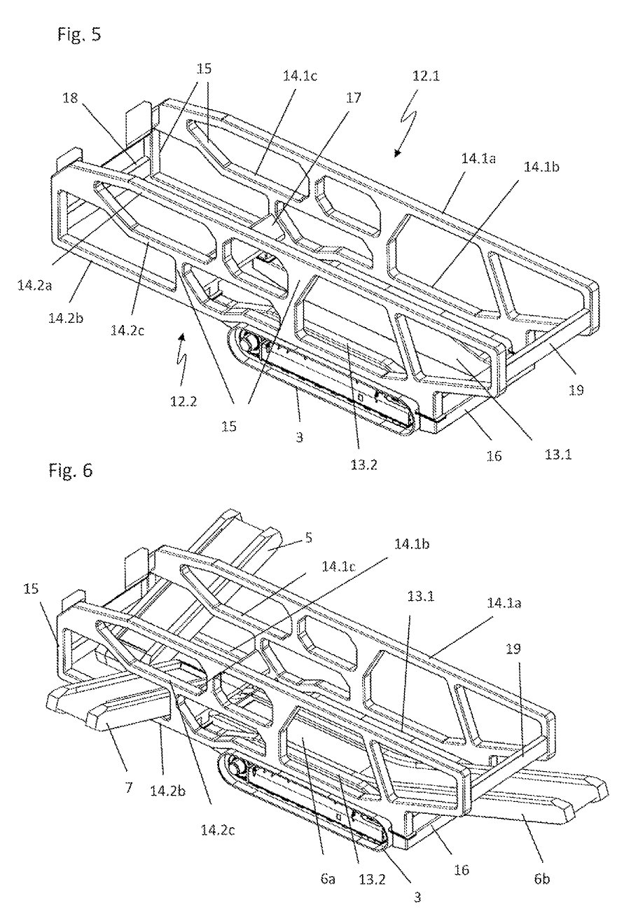

FIG. 6 shows a perspective view of the illustration of FIG. 5 with continuous conveyors added for the classifying or screening device according to FIG. 1,

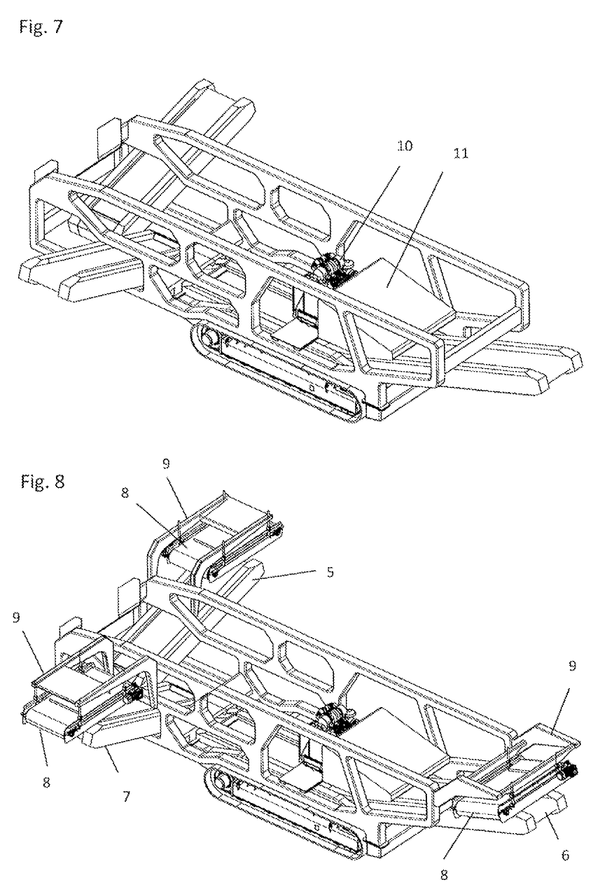

FIG. 7 shows a perspective view of the illustration of FIG. 6 with added drive and hydraulic devices for the classifying or screening device according to FIG. 1,

FIG. 8 shows a perspective view of the illustration of FIG. 7 with added magnetic separators for the classifying or screening device according to FIG. 1,

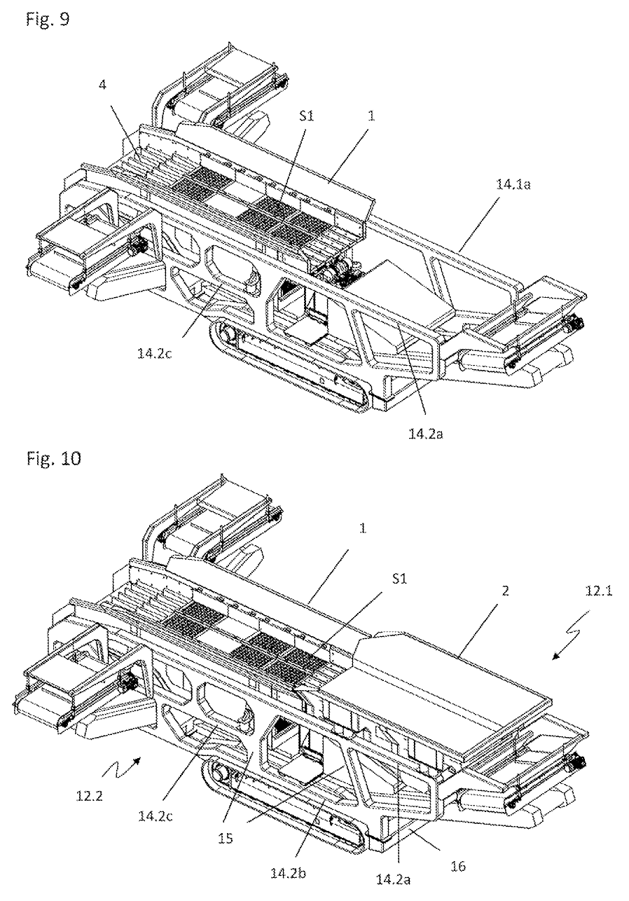

FIG. 9 shows a perspective view of the illustration of FIG. 8 with added classifying apparatus for the classifying or screening device according to FIG. 1,

FIG. 10 shows a perspective view of the illustration of FIG. 9 with added feed channel for the classifying or screening device according to FIG. 1, and

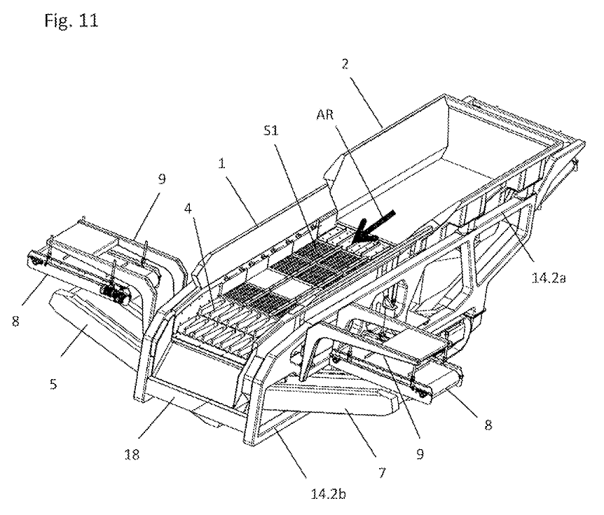

FIG. 11 shows another perspective view of the illustration of FIG. 10.

First of all, reference is made to FIGS. 1-3 in order to explain the mode of operation of the classifying or screening device according to the invention, before the structure of the classifying or screening device is described in further detail on the basis of an exemplary embodiment. The embodiment shown has a chassis which is designed as a crawler chassis with two crawler tracks 3. Furthermore, the storage and metering unit 2 for the fed screening materials SG, which is designed as a trough-shaped feed channel, can be seen, as well as the classifying apparatus 1 arranged next to it. In the exemplary embodiment shown, the classifying apparatus 1 is designed in such a way that it has two screening decks lying one above the other, which form two screening surfaces S1, S2. The classifying apparatus 1 also has a wedge wire screen 4 arranged downstream of the upper, first, screening deck (see in particular FIG. 3). In the feed channel, the screening materials SG, which are sometimes fed in batches, are calmed and fed in a metered manner in a substantially horizontal discharge direction AR (see FIG. 1) to the upper screening deck of the classifying apparatus 1, in that the feed channel is designed as a vibrating chute. In the exemplary embodiment shown, the classifying apparatus 1 is designed as a vibrating screening device with a directed, elliptical vibration pattern, so that the screening materials SG are moved to the left in the classifying apparatus 1 with respect to FIG. 1. In this case, a mixture of a medium coarse and fine screening fraction MFF falls from the first, upper screening surface S1 onto the second screening surface S2 below (see FIG. 1). A coarse fraction GF of the screening materials SG reaches the wedge wire screen 4 and falls there onto an underlying coarse fraction conveyor 5, which is designed as a continuous conveyor discharging the coarse fraction GF laterally next to the device (see in particular also FIG. 2). Those parts of the screening fraction which are too large to fall through the wedge wire screen 4 are discharged at the rear end of the device as oversize material ÜG (see in particular FIGS. 1 and 3) .

The mixture of the medium coarse and fine screening fraction MFF falls in the classifying apparatus 1 from the first, upper screening surface S1 onto the second screening surface S2 below, as mentioned. The fine screening fraction FF also falls through the second screening surface S2 and is collected on an underlying fine fraction conveyor 6. The fine fraction conveyor 6 is designed as a continuous conveyor that conveys the fine fraction FF in a horizontal conveying section 6a in the longitudinal direction of the device to the front end of the device, where it changes into an ascending conveying section 6b and discharges the fine fraction FF in front of the device at its elevated discharge end (see FIGS. 1 and 3). That fraction of the medium-coarse and fine screening fraction MFF which is too coarse to fall through the second screening surface S2 is discharged at the left-hand end of the classifying apparatus 1, as shown in FIG. 1, as medium fraction MF onto a medium-fraction conveyor 7 lying below, which is also designed as a continuous conveyor that discharges the medium fraction MF laterally next to the device (see in particular also FIG. 2).

FIGS. 1-3 also show that magnetic separators 8 are arranged above the respective discharge ends of the continuous conveyors for the discharged screening fractions, which in the embodiment shown are attached to holders 9 and remove magnetically attractable material components from the respective discharged screening fraction. With the aid of a magnetic separator 8 arranged above the discharge end of the coarse fraction conveyor 5, the coarse fraction GF is separated into a non-magnetic coarse fraction GFᵤₘ and a magnetic coarse fraction GFₘ (see in particular FIG. 2). By means of a magnetic separator 8 arranged above the discharge end of the medium fraction conveyor 7, the medium fraction MF is separated into a non-magnetic medium fraction MFᵤₘ and a magnetic medium fraction MFₘ. Furthermore, with the aid of a magnetic separator 8 arranged above the discharge end of the fine fraction conveyor 6, the fine fraction FF is separated into a non-magnetic fine fraction FFᵤₘ and a magnetic fine fraction FFₘ (see in particular FIG. 3). Admittedly, this type of classification according to the magnetic properties of the screening materials SG is optional. Preferably, the magnetic separators 8 can also be fixed in the holders 9 in a height-adjustable manner in order to be able to adjust to different magnetization properties of the magnetically attractable material fractions. Preferably, layer height limiters or a layer height comparator can also be provided in order to optimally prepare the layer height of the discharged screening fractions for magnetic separation and thus improve the separation of magnetically attractable material components.

Furthermore, the drive and/or hydraulic devices 10 for driving the crawler chassis as well as for driving the storage and metering unit 2 and the classifying apparatus 1 can be seen in FIGS. 1-3. Fuel and hydraulic fluids for the drive and/or hydraulic devices 10 are stored in a tank 11.

In the following, FIGS. 4-11 will be used to explain the structure of the classifying or screening device in more detail step by step on the basis of an exemplary embodiment. This explanation starts in FIG. 4, which initially shows only the frame with two lateral frame parts 12.1, 12.2 and the two longitudinal beams 13.1, 13.2. The two lateral frame parts 12 are each formed by longitudinal bars 14 extending in the longitudinal direction, which are connected by webs 15 extending transversely to the longitudinal bars and comprise an uppermost longitudinal bar 14a and a lowermost longitudinal bar 14b, as well as a central longitudinal bar 14c extending between the uppermost longitudinal bar 14a and the lowermost longitudinal bar 14b. For the left frame part 12.1 shown in FIG. 4, these longitudinal bars 14 are referred to as the uppermost longitudinal bar 14.1a, the lowermost longitudinal bar 14.1b and the central longitudinal bar 14.1c. For the right frame part 12.2 shown in FIG. 4, these longitudinal bars 14 are designated as uppermost longitudinal bar 14.2a, as lowermost longitudinal bar 14.2b and as central longitudinal bar 14.2c. The longitudinal bars 14 run horizontally, at least in sections, and form bearing surfaces for the classifying apparatus 1 and the storage and metering unit 2 in the horizontal sections, as will be described in more detail below.

In the shown exemplary embodiment, the two lateral frame parts 12.1, 12.2 are connected to each other by a total of four transverse bars 16-19, each of which extends in the transverse direction, namely by a front transverse bar 16, an inner transverse bar 17 and a rear transverse bar 18, which connect the two frame parts 12.1, 12.2 to each other in the region of their respective lowermost longitudinal bars 14b, as well as an upper transverse bar 19, which connects the two frame parts 12.1, 12.2 above the aforementioned transverse bars 16-18. The front transverse bar 16 and the inner transverse bar 17 are connected to each other by the two aforementioned longitudinal beams 13.1, 13.2.

The arrangement shown in FIG. 4 forms a torsionally rigid frame which is supported on the crawler chassis, as indicated in FIG. 5. In FIG. 5, the two crawler tracks 3 of the crawler chassis are shown, and it can be seen that the two longitudinal beams 13 extend inside the two crawler tracks 3 and at approximately the same height as the two crawler tracks 3. The two longitudinal beams 13 thus delimit a receiving space located between them, which is the deepest receiving space of the entire device.

This low-lying receiving space receives the horizontal conveying section 6a of the fine fraction conveyor 6 for discharging the fine fraction FF, as can be seen in FIG. 6. This horizontal conveying section 6a begins in an end region of the longitudinal beams 13 facing the inner transverse bar 17, and in an end region of the longitudinal beams 13 facing the front transverse bar 16, merges into a rising conveying section 6b, which subsequently extends above the front transverse bar 16 and below the upper transverse bar 19. The horizontal conveying section 6a thus extends inside the device in the area close to the ground, since the fine fraction FF is obtained at the lowest point of the classifying apparatus 1. It also extends below the storage and metering unit 2 and only reaches an elevated level for discharging the fine fraction FF at the discharge end of the rising conveyor section 6b.

FIG. 6 also shows the medium fraction conveyor 7 and the coarse fraction conveyor 5, which discharge the coarser screening fractions at opposite sides of the device and respectively cross discharge openings of the frame parts 12 formed by the lowermost longitudinal bar 14b, the central longitudinal bar 14c and the nearest webs 15. As has already been mentioned, the discharge openings also represent discharge openings for the medium fraction conveyor 7 and the coarse fraction conveyor 5, since these continuous conveyors for the coarser screening fractions protrude laterally from the device in the operating state and must therefore be dismantled or folded in the event of transport of the mobile classifying and screening device. With the help of the opening in the frame formed by the middle longitudinal bar 14c and the lowest longitudinal bar 14b, this disassembly is easily possible.

FIG. 7 shows the arrangement of the drive and/or hydraulic devices 10 for driving the crawler track, the storage and metering unit 2 and the classifying apparatus 1. Propellants and hydraulic fluids for the drive and/or hydraulic devices 10 are stored in a tank 11. Both the drive and/or hydraulic devices 10 and the tank 11 are arranged above the horizontal conveying section 6a of the fine fraction conveyor 6, for example on a support plate, as indicated in FIG. 7.

In FIG. 8, in comparison with FIG. 7, the magnetic separators 8 are added, which are arranged above the respective discharge ends of the continuous conveyors for the discharged screening fractions and are attached to holders 9, which in turn are mounted on the frame parts 12. With the aid of a magnetic separator 8 arranged above the discharge end of the coarse fraction conveyor 5, the coarse fraction GF is separated into a non-magnetic coarse fraction GFᵤₘ and a magnetic coarse fraction GFₘ, wherein both the non-magnetic coarse fraction GFᵤₘ, and the magnetic coarse fraction GFₘ are discharged in the transverse direction of the device. With the aid of a magnetic separator 8 arranged above the discharge end of the medium fraction conveyor 7, the medium fraction MF is separated into a non-magnetic medium fraction MFᵤₘ, and a magnetic medium fraction MF_{m,} with both the non-magnetic medium fraction MFᵤₘ and the magnetic medium fraction MFₘ being discharged in the transverse direction of the device. Furthermore, with the aid of a magnetic separator 8 arranged above the discharge end of the fine fraction conveyor 6, the fine fraction FF is separated into a non-magnetic fine fraction FFᵤₘ and a magnetic fine fraction FFₘ, with the non-magnetic fine fraction FFᵤₘ being discharged in the longitudinal direction of the device and the magnetic fine fraction FFₘ being discharged in the transverse direction of the device (see also FIG. 3).

In FIG. 9, the classifying apparatus 1 has been added in comparison with FIG. 8, wherein it can be seen in particular that the classifying apparatus 1 in the embodiment shown is supported on horizontally extending sections of the central longitudinal bars 14c via elastic bearings. The vibration excitation of the classifying apparatus 1 is carried out with the aid of the drive and hydraulic device 10.

Finally, FIGS. 10 and 11 show the complete device including the storage and metering unit 2. The storage and metering unit 2 is supported on the uppermost longitudinal bars 14a by elastic bearings. The vibration excitation of the storage and metering unit 2 is also carried out with the aid of the drive and hydraulic device 10. The classifying apparatus 1 and the storage and metering unit 2 are arranged in such a way that the upper screening surface S1 of the classifying apparatus 1 is located approximately at the level of the tank bottom of the storage and metering unit 2, which is designed as a feed channel, so that an essentially horizontal discharge direction AR for the screening materials SG onto the upper screening surface S1 is made possible.

With the aid of the shown design of the frame and the arrangement of the classifying apparatus 1 and the storage and metering unit 2, the maximum width of heavy-duty vehicles permitted for road transport can be optimally utilized both with regard to the track width of the crawler track and with regard to the overall width of the device. The screening surfaces S1, S2 can thus be enlarged because their dimension in the transverse direction can be maximized so that it lies within the range of this permitted maximum width. However, a larger screening surface S compared to conventional designs also means a larger throughput of screening materials SG and thus a higher screening capacity of the classifying or screening device. In addition, very low installation heights can be achieved, so that, for example, direct feeding of the feed channel with a wheel loader and a design as a heavy-duty screen is also possible.

1. A mobile classifying or screening device having a chassis and a frame arranged on the chassis for a classifying apparatus having at least one screening surface for separating a fed screening material into at least two screening fractions, wherein the chassis has a longitudinal direction oriented in the direction of travel and a transverse direction oriented perpendicular to the longitudinal direction, wherein the frame comprises two lateral frame parts, each formed by longitudinal bars extending in the longitudinal direction, connected by webs extending transversely to the longitudinal bars and comprising an uppermost longitudinal bar and a lowermost longitudinal bar, and at least two transverse bars extending in the transverse direction and connecting the two lateral frame parts to each other in the region of their respective lowermost longitudinal bars, wherein the classifying apparatus is mounted on longitudinal bars and a storage and metering unit, which is arranged adjacent to the classifying apparatus and mounted on longitudinal bars, is provided for the screening material and is designed as a trough-shaped delivery channel with a substantially horizontal delivery direction for the screening material from the delivery channel onto the adjacent screening surface.

2. The mobile classifying or screening device according to claim 1, wherein the transverse bars comprise a front transverse bar lying in front of the chassis, as seen in the longitudinal direction, and an inner transverse bar lying behind the chassis, as seen in the longitudinal direction, wherein the inner transverse bar is connected to the front transverse bar by two longitudinal beams extending in the longitudinal direction.

3. The mobile classifying or screening apparatus according to claim 2, wherein a fine fraction conveyor designed as a continuous conveyor is provided for a fine fraction forming the finest screening fraction, which conveyor has a horizontal conveying section (6a)-which extends between the two longitudinal beams and begins in an end region of the longitudinal beams facing the inner transverse bar and, in an end region of the longitudinal beams facing the front transverse bar, merges into a rising conveying section, the discharge end of which lies above the front transverse bar.

4. The mobile classifying or screening device according to claim 1, wherein the two frame parts each have a central longitudinal bar extending between the uppermost longitudinal bar and the lowermost longitudinal bar, which central bar, together with the respective lowermost longitudinal bar, in each case forms a discharge opening for the passage of continuous conveyors, extending in the transverse direction, for coarser screening fractions.

5. The mobile classifying or screening device according to claim 4,wherein the classifying apparatus is mounted on the central longitudinal bars.

6. The mobile classifying or screening device according to claim 1, wherein the storage and metering unit is mounted on the uppermost longitudinal bars.

7. The mobile classifying or screening device according to claim 1, wherein the trough-shaped feed channel is designed as an integral vibrating chute.

8. The mobile classifying or screening device according to claim 1, wherein continuous conveyors for discharging the screening fractions and magnetic separators arranged above the continuous conveyors for classifying magnetically attractable material components of the respectively discharged screening fraction are provided.

9. The mobile classifying or screening device claim 1, wherein a maintenance opening for drive and/or hydraulic devices is formed between the uppermost longitudinal bar and the lowermost longitudinal bar of a frame part.

10. The mobile classifying or screening device according to claim 1, wherein the longitudinal bars and/or the webs are designed at least in sections as hollow profiles for receiving fuel and/or hydraulic fluid.
